(19) United States
(12) Patent Application Publication
(10) Pub. No.: US 2003/0126044 A1
(43) Pub. Date: Jul. 3, 2003

(54) Stand-alone intranet search apparatus and system

(76) Inventor: Brooks Lucas, Boon, MI (US)

Correspondence Address: IRVING M. WEINER, WEINER & BURT, P.C., 635 N. US-23, P.O. BOX 186, HARRISVILLE, MI, 48740, US

(21) Appl. No.: 10/278,375

(22) Filed: Oct. 22, 2002

Related U.S. Application Data
(60) Provisional application No. 60/344,578, filed on Dec. 28, 2001.

(51) Int. Cl. G06F 17/60

(52) U.S. Cl. 705/28

(57) ABSTRACT

A stand alone Intranet product search device, composed of a main touch-screen computer which is linked to a store's product inventory Intranet, thereby accessing product locations by aisle and shelve locations. Additionally, product location may be shown on a store layout, highlighting the product's location.

The present patent application claims priority from U.S. Provisional Patent Application Serial No. 60/344,578 filed Dec. 28, 2001.

### BACKGROUND OF THE INVENTION

The present invention relates generally to a new and useful stand-alone intranet search apparatus and system.

More particularly, the present invention relates to a novel stand-alone intranet search apparatus and system to facilitate finding products in large stores without the aid of customer representative.

Today's world is very active and people are constantly in a hurry. Many superstores are very large, and often have several million items on their shelves. Consequently, items are very difficult to locate. Indeed, the representatives at the superstore themselves have a difficult time locating items as well.

High tech devices are becoming very prominent every day. Furthermore, members of the public are adapting to interactive high tech devices for convenience, such as the U-Scan T device in use in many superstores today.

The relevant art is exemplified by the following United States Patents:

U.S. Pat. No. 3,426,326 issued in 1969 to Goldstein, entitled “AUTOMATIC INVENTORY DATA ACQUISITION APPARATUS”;

U.S. Pat. No. 5,880,449 issued in 1999 to Teicher et al, entitled “SYSTEM AND METHOD FOR PROVIDING A STORE CUSTOMER WITH PERSONALLY ASSOCIATED PRICES FOR SELECTED ITEMS”; and

U.S. Pat. No. 6,105,004 issued in 2000 to Halperin et al, entitled “PRODUCT MONITORING SYSTEM PARTICULARLY USEFUL IN MERCHANDISING AND INVENTORY CONTROL”.

It is a desiradatum of the present invention to avoid the animadversions of the prior techniques, systems and devices.

### SUMMARY OF THE INVENTION

The present invention provides a stand-alone Intranet search device to facilitate finding products in stores without the aid of a customer representative, comprising: a product inventory Intranet for said store including the location coordinates for each product; and a main computer linked to said product inventory Intranet permitting a customer to enter the product desired, and whereby the location of said desired product is displayed on a store layout.

The present invention also provides a main computer which is a touch-screen computer allowing said customer to enter said desired product by touching the screen of said main computer.

The present invention also provides a device wherein said coordinates for said desired product are located by aisle and shelf locations in said store. Said product inventory Intranet for said store comprises a product database server and wherein said main computer is disposed in a product search kiosk. A plurality of said main computers are linked to said product inventory Intranet of said store.

The present invention further provides a plurality of said main computers linked to said product inventory Intranet of said store.

The present invention possesses many other advantages and features which will become more apparent to those persons skilled in this particular form of technology and to other persons after having read the following detailed description of the present invention as set forth hereinbelow in conjunction with the accompanying drawings.

### BRIEF DESCRIPTION OF THE DRAWINGS

FIG. 1 illustrates in schematic form a preferred embodiment of the present invention.

FIG. 2 illustrates a flow chart showing the typical operation of a preferred embodiment of the present invention.

### DETAILED DESCRIPTION OF THE INVENTION

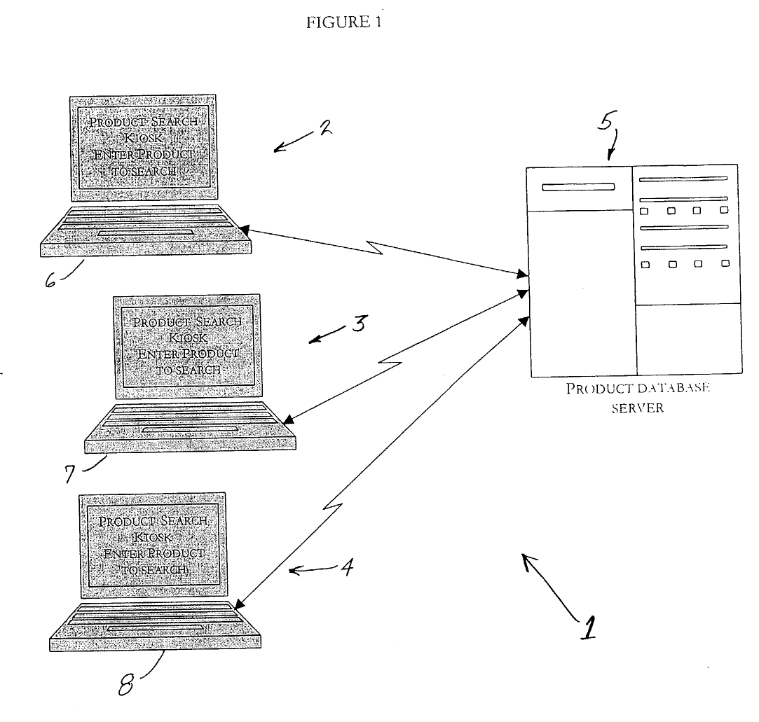

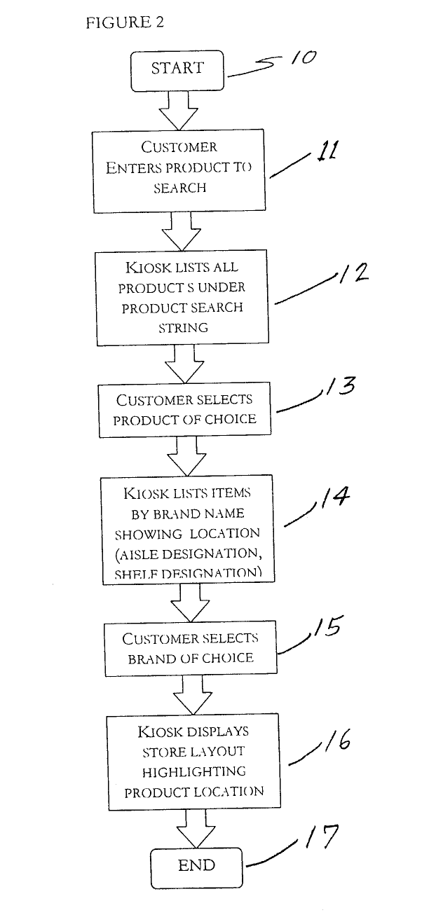

With reference to FIG. 1, there is illustrated a stand-alone intranet search apparatus and system 1 in accordance with the present invention. The system 1 includes a plurality of product search kiosks 2, 3 and 4, each of which is linked to the product database server 5 of the store or other facility wherein which the system 1 is installed. With reference to FIG. 2, there is illustrated a flow chart of the functional operation of the stand-alone intranet search apparatus and system 1 in accordance with the present invention.

When the potential customer enters the store, and desires to locate one or more products for possible purchase thereof, the potential customer would approach and/or enter one of the several product search kiosks 2, 3 or 4. Each such kiosk 2, 3 and 4, includes a touch-screen computer 6, 7 and 8, respectively, which is linked to the product database server 5.

With reference to FIG. 2, there is illustrated a flow chart of the functional operation of what transpires when the potential customer operates the computer in the kiosk.

The sequence of steps are:

“START” 10;

“CUSTOMER ENTERS PRODUCT FOR SEARCH” 11;

“KIOSK LISTS ALL PRODUCTS UNDER PRODUCT SEARCH STRING” 12;

“CUSTOMER SELECTS PRODUCT OF CHOICE” 13;

“KIOSK LISTS ITEMS BY BRAND NAME SHOWING LOCATION (AISLE DESIGNATION, SHELF DESIGNATION)” 14;

“CUSTOMER SELECTS BRAND OF CHOICE”15;

“KIOSK DISPLAYS STORE LAYOUT HIGHLIGHTING PRODUCT LOCATION” 16;

“END” 17.

The operation of the stand-alone intranet search apparatus and system 1 of the present invention can also be explained as set forth hereinbelow.

When the potential customer enters the superstore, the customer would see one or more of the kiosks 2, 3 and 4 for product location. The screen of the computer 6, 7 or 8 in the kiosk 2, 3 or 4, respectively, would read “Enter Product”.

The customer would then enter, for example, “fried onions” on the keypad/screen and continue by pressing the enter key.

The product database server 5 then searches the store's product database for products, whereby the search replies with all items containing “fried onions” in the product description field.

The potential customer would then select the desired product from the initial search by touching the screen on that word or words.

The computer 6, 7 or 8 in the kiosk 2, 3 or 4, respectively, would then list the items by brand name in alphabetical order, showing the aisle and shelf designation.

If the potential customer knows the basic location of the aisle, the customer may then go and get the desired product.

If the customer is new to the store, the customer may touch the screen on the desired product, whereby the computer 6, 7 or 8 in the kiosk 2, 3 or 4, respectively, displays a store layout showing current locations and the location of the product by highlighting the aisle and general location of the aisle.

At this point, the screen on the computer 6, 7 or 8 in the kiosk 2, 3 or 4, respectively, would ask the customer if the customer desires printing or searching again.

There has been illustrated in the accompanying drawings and described hereinabove only one unique and novel preferred embodiment of the present invention which may be configured, arranged and constructed in many different configurations, arrangements of components, etc. It should be understood that many changes, modifications, variations, and other uses and applications will become apparent to those persons skilled in this particular area of technology and to other persons after having been exposed to the present patent specification and accompanying patent drawings.

Any and all such changes, modifications, variations and other uses and applications which do not depart from the spirit and scope of the present invention are therefore covered by and embraced within the present invention and patent application.

1. A stand alone Intranet search device to facilitate finding products in stores without the aid of a customer representative, comprising:
a product inventory Intranet for said store including the location coordinates for each product; and
a main computer linked to said product inventory Intranet permitting a customer to enter the product desired, and whereby the location of said desired product is displayed on a store layout.

2. A device according to claim 1, wherein:
said main computer is a touch-screen computer allowing said customer to enter said desired product by touching the screen of said main computer.

3. A device according to claim 1, wherein:
said coordinates for said desired product are located by aisle and shelf locations in said store.

4. A device according to claim 2, wherein:
said coordinates for said desired product are located by aisle and shelf locations in said store.

5. A device according to claim 1, wherein:
said product inventory Intranet for said store comprises a product database server.

6. A device according to claim 2, wherein:
said product inventory Intranet for said store comprises a product database server.

7. A device according to claim 3, wherein:
said product inventory Intranet for said store comprises a product database server.

8. A device according to claim 4, wherein:
said product inventory Intranet for said store comprises a product database server.

9. A device according to claim 1, wherein:
said main computer is disposed in a product search kiosk.

10. A device according to claim 2, wherein:
said main computer is disposed in a product search kiosk.

11. A device according to claim 3, wherein:
said main computer is disposed in a product search kiosk.

12. A device according to claim 4, wherein:
said main computer is disposed in a product search kiosk.

13. A device according to claim 5, wherein:
said main computer is disposed in a product search kiosk.

14. A device according to claim 6, wherein:
said main computer is disposed in a product search kiosk.

15. A device according to claim 7, wherein:
said main computer is disposed in a product search kiosk.

16. A device according to claim 8, wherein:
said main computer is disposed in a product search kiosk.

17. A device according to claim 1, including:
a plurality of said main computers linked to said product inventory Intranet of said store.

18. A device according to claim 8, including:
a plurality of said main computers linked to said product inventory Intranet of said store.

19. A device according to claim 16, including:
a plurality of said main computers linked to said product inventory Intranet of said store

20. A stand alone Intranet search system to facilitate locating products in a store without the aid of customer representatives, comprising the steps of:
entering into a computer a desired product to be searched;
said computer listing all products under a product search string;
selecting the product of choice;
said computer listing products by brand name showing locations including aisle designation and shelf designation;
selecting a brand of choice; and
said computer displaying a store layout highlighting the location of said desired product.
